(19) United States
(12) Patent Application Publication
(10) Pub. No.: US 2026/0222454 A1
(43) Pub. Date: Jul. 30, 2026

(54) FAILURE HANDLING MECHANISM FOR MISSING ATTRIBUTE VALUE PAIR

(71) Applicant: T-MOBILE INNOVATIONS LLC, Overland Park (WA)

(72) Inventors: Rahul AMIN, Issaquah, WA (US); Joel ARENDS, Renton, WA (US); Tingchun KANG, Redmond, WA (US); Madhuri KOTTA, Bellevue, WA (US); Ryan McGINN, Shawnee, KS (US)

(21) Appl. No.: 19/041,380

(22) Filed: Jan. 30, 2025

(51) Int. Cl. H04L 65/1016; H04L 65/1045; H04L 65/1104; H04W 12/06

(52) U.S. Cl. CPC H04L 65/1016; H04L 65/1045; H04L 65/1104; H04W 12/06

(57) ABSTRACT

Methods and systems provided herein include a failure handling mechanism designed to prevent errors in generated dedicated bearers. The failure handling mechanism may be incorporated in a system performing multiple operations. The operations may include analyzing a request from a requesting function and identifying a missing attribute value pair (AVP) in the request based on the analysis. The operations may additionally include inserting a missing AVP indicator into an answer to the request. Additionally, the operations may include identifying an AVP corresponding to the missing AVP indicator and generating a further request to be sent from the requesting function including the identified corresponding AVP.

### TECHNICAL BACKGROUND

As wireless networks evolve and grow, there are ongoing challenges in communicating data across different types of networks. For example, a wireless network may include one or more access nodes, such as base stations, including, for example, evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, 6G networks, as well as 4G long-term evolution (LTE) access nodes.

5G networks include a core network utilizing a service based architecture (SBA) with multiple network functions (NFs). Further, most evolving networks include an IP multimedia subsystem (IMS) having NFs communicating with the NFs in the core network. During the evolution of newer wireless RATs, improved voice services have become available. For example, with 4G networks, Voice over Long-Term Evolution (VoLTE), which is an LTE high speed wireless communication standard for voice calls became available. Further, with the development of 5G networks, Voice over New Radio (VoNR), which fully utilizes the 5G standalone (SA) core network was developed. In either case, to support VoLTE or VoNR, a network must utilize an IMS.

NFs at the IMS may establish a session with an NF at the core network that requires deployment of a dedicated bearer linked to an existing default bearer. For example, NFs such as the proxy call session control function (PCSCF) in the IMS require deployment of a dedicated bearer linked to an existing IMS signaling session default bearer to provide dedicated traffic user-plane resources for IMS services such as, for example voice and video. Requests from the IMS NFs to establish a session include attribute value pairs (AVPs) that contain application service data information such as media components and bandwidth required for dedicated bearer setup. For example, the AVPs are sent in a session establishment request from the PCSCF to a policy control function (PCF) in 5G networks and policy control and rules function (PCRF) in 4G LTE networks in a request.

However, instances arise in which the requesting NF fails to include all of the required AVPs in the request. For example, the PCSCF fails to include all required AVPs in the request to the PCF or PCRF. Missing AVPs can result in dedicated bearer setup failure causing associated application session failures such as a voice call setup failure. Such failures result in degraded network quality of service (QoS) and hence negatively impact the customer experience.

### OVERVIEW

Exemplary embodiments provided herein include a method and system for failure handling implementing a failure handling mechanism in the context of requests from a requesting function to an answering function. A method includes analyzing a request from the requesting function and identifying a missing attribute value pair (AVP) in the request based on the analysis. The method further includes inserting a missing AVP indicator into an answer to the request. The method further includes identifying an AVP corresponding to the missing AVP indicator and triggering generation of a further request to be sent from the AF including the identified corresponding AVP.

Embodiments disclosed herein further include a failure handling system. The system includes a memory storing data and instructions and at least one processor executing the stored instructions to perform multiple operations. The operations include identifying a missing attribute value pair (AVP) in a request from a requesting function and inserting a missing AVP indicator into an answer to the request. The operations additionally include identifying an AVP corresponding to the missing AVP indicator and triggering generation of a further request to be sent from the requesting function including the identified corresponding AVP.

In a further embodiment, a non-transitory computer-readable medium stores instructions executed by a processor to perform multiple operations. The operations may include identifying a missing attribute value pair (AVP) in a request from a requesting function and inserting a missing AVP indicator into an answer to the request. The operations may additionally include identifying an AVP corresponding to the missing AVP indicator and triggering generation of a further request to be sent from the requesting function including the identified corresponding AVP.

Further embodiments include proxy call session control functions (PCSCFs), policy control functions (PCFs), policy control and rules functions (PCRFs), and processing nodes performing the operations described above.

### BRIEF DESCRIPTION OF THE DRAWINGS

FIG. 1 depicts an exemplary environment for a failure handling system in accordance with an embodiment.

FIG. 2 depicts a failure handling system in accordance with an embodiment.

FIG. 3 depicts an exemplary method for failure handling in accordance with an embodiment.

FIG. 4 depicts an exemplary method for failure handling from an answering function in accordance with an embodiment.

FIG. 5 depicts a further exemplary method for failure handling from a requesting function in accordance with an embodiment.

FIG. 6A depicts a dedicated bearer deployment failure in accordance with existing procedures.

FIG. 6B depicts an additional exemplary method for failure handling in order to deploy a dedicated bearer in accordance with an embodiment.

### DETAILED DESCRIPTION

In embodiments disclosed herein, functionality for handling failures, for example, during the process of deployment of dedicated bearers for services of an Internet protocol multimedia subsystem (IMS) is provided. While the failure handling mechanism is described herein with specific context, the failure handling mechanism may operate based on interactions between a number of network functions (NFs), wherein one NF operates as a requesting function and another NF operates as an answering function.

In embodiments provided herein, the failure handling mechanism analyzes requests from a requesting function in the form of a proxy call session control function (PCSCF) to identify missing attribute value pairs (AVPs). Any number of AVPs may be missing from the request. The PCSCF may be located in an IMS core and the request may be transmitted to a control plane function in a core network connected with a radio access network (RAN).

In specific embodiments disclosed herein, the request is transmitted over an Rx interface between the PCSCF and a policy control function (PCF) or policy control and rules function (PCRF). The request may be or include a request for a dedicated bearer to be linked to a default bearer and may further establish an application level session, such as an IMS session, which requires a session set-up with an explicit session description before the use of a requested service, such as voice or video service provided by the IMS.

As set forth above, the failure handling functionality performs an analysis to identify missing AVPs in a request. The AVP corresponds to an information element (IE) in a diameter message, such as an Rx authentication and authorization (AA) request or an Rx/AA answer. An objective of the failure handling mechanism is to identify one or more missing AVPs in a request, such as an Rx/AA request. An objective further includes triggering generation of a response to the request in an answer. The answer may, for example, be or include an Rx/AA answer that provides an indicator of missing AVP information. Embodiments disclosed herein subsequently identify the missing AVP information based on the indicator in the answer and generate a further request, such as a retry Rx/AA request with any missing AVPs inserted.

In specific embodiments described herein, the NFs involved are specific to IMS services and include the PCSCF as the requesting function for originating and retrying Rx/AA requests and the PCF or PCRF as the answering function for processing the Rx/AA request and subsequently responding with an Rx/AA answer with an indicator of any missing AVP information. The failure handling mechanism and its implementation on the PCSCF and PCF/PCRF is further described herein.

Thus, the failure handling mechanism may function as an application session failure handling mechanism ensuring that a dedicated bearer can be set up even when the Rx/AA request has one or more missing AVPs. When a requesting function such as the PCSCF sends the Rx/AA request with missing AVPs, the answering function (PCF or PCRF) responds with an Rx/AA answer with an experimental-result-code AVP set to a value as aligned on both the requesting and answering functions. The PCSCF upon processing the Rx/AA-answer and detecting the aligned experimental-result-code AVP value will transmit a further Rx/AA-request after inserting or adding the missing AVP. This process results in successful dedicated bearer setup and a successful application session binding.

Accordingly, embodiments described herein facilitate deployment of a dedicated bearer for application sessions. The failure handling mechanism reduces incidence of error messages and excess traffic, thereby improving network performance and reducing customer impact.

In addition to the systems and methods described herein, non-transitory computer-readable mediums may store the operations for the instructions or methods. Further, processing nodes on the network may execute the instructions or methods. The processing node may include a processor included in a network function, such as for example, the PCSCF, the PCF and/or the PCRF and/or a processor included in any controller node in the wireless network.

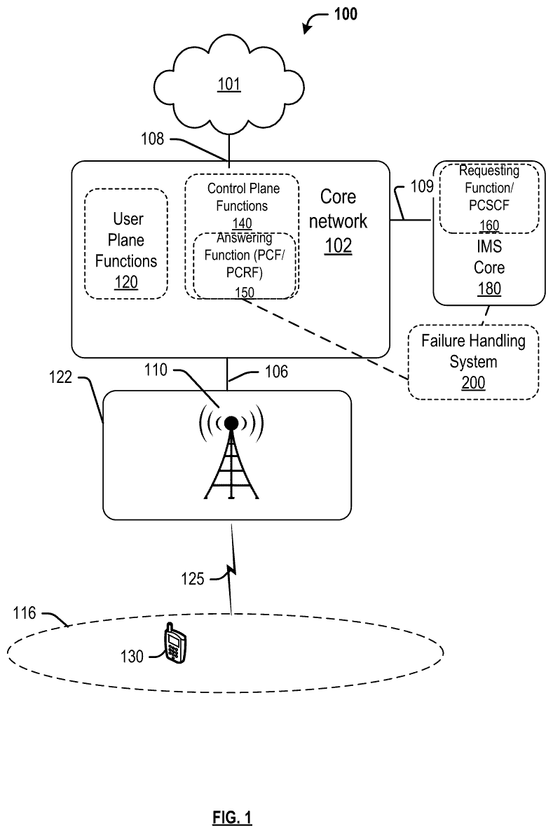

FIG. 1 depicts an exemplary environment 100 for implementing a failure handling system 200. Environment 100 comprises a communication network 101, core network 102, and a radio access network (RAN) 122 including at least an access node 110. Wireless device 130 is located in a coverage area 116 and communicates with the access node 110 over communication link 125. Although only one wireless device 130 is shown, it should be understood that any number of wireless devices could be included. Further, the failure handling system 200 interacts with the core network 102, which includes control plane functions 140 and user plane functions 120. The failure handling system 200 also communicates with an IMS core 180. Specifically, the failure handling system 200 operates between a requesting function 160 in the IMS core 180 and an answering function 150 in the core network 102 to identify missing information in the request and insert an indicator of the missing information into an answer from the answering function 150. The failure handling system 200 further operates to trigger identification of the missing information in the answer and trigger a further request from the requesting function 150 based on the identification, wherein the further request includes the identified missing information. The missing information may include missing attribute value pairs (AVPs).

The core network 102 may include an SBA architecture, in which service-based interfaces may be utilized between control plane functions 140, while multiple UPFs 120 connect over point-to-point link. The UPF 120 accesses a data network, such as network 101, and performs operations such as packet routing and forwarding, packet inspection, policy enforcement for the user plane, quality of service (QoS) handling, etc. The control plane functions 140 include the answering function 150, which in embodiments provided herein may be or include a policy control function (PCF) in 5G implementations or policy control and rules function (PCRF) in 4G LTE implementations.

The IMS core 180 is standards-based architectural framework for delivering multimedia communications services such as voice, video and text messaging over IP networks. The IMS core 180 may include a requesting function 160, which may be or include a proxy call session control function (PCSCF). The PCSCF 160 acts as the ingress and egress point to and from the IMS core 180 with respect to an IMS client, such as the wireless device 130. The PCSCF 160 has responsibilities including, for example, routing of registration and session requests to the correct nodes in the network and providing session information to the PCRF or PCF 150.

The PCSCF 160 analyzes and extracts information from session initiation protocol (SIP) or session description protocol (SDP) message in an IMS signaling session. The PCSCF 160 adds additional service and subscriber specific information to create a request (Rx/AA request) transmitted over the Rx interface to the PCF or PCRF 150. The PCSCF 160 is responsible for routing of registration and session requests and providing session information to the PCF/PCRF 150 as well as maintaining a secure connection with the wireless device 130.

When the requesting function is the PCSCF 160 and the answering function is the PCF/PCRF 150, communication occurs over an Rx interface that enables allocation of data resources required for a media session. Via the Rx interface, the PCSCF 160 provides session information to the PCF/PCRF 150 utilizing the Rx/AA request. The PCF/PCRF 150 then informs the PCSCF 160 of traffic plane events.

The failure handling system 200 is illustrated as communicating with the core network 102 and the IMS core 180. In some embodiments, the failure handling system 200 may be incorporated in or in direct communication with the PCSCF 160 and/or the PCF/PCRF 150.

The RAN 122 can include various access network functions and devices disposed between the core network 102 and the end-user wireless device 130. For example, the RAN 122 includes at least an access node (or base station), such as an eNodeB and/or a next generation NodeB (gNodeB) 110 communicating with the end-user wireless device 130. Further, either of core network 102 and radio access network 122 can include one or more of a local area network, a wide area network, and an internetwork (including the Internet) and be capable of communicating signals and carrying data, for example, to support voice, push-to-talk, broadcast video, and data communications by end-user wireless device 130.

Access node 110 can be any network node configured to provide communication between end-user wireless device 130 and communication network 101, including standard access nodes and/or short range, low power, small access nodes. For instance, access node 110 may include any standard access node, such as a macrocell access node, base transceiver station, or a radio base station, or the like. In embodiments further discussed herein, the access node 110 is a next generation NodeB (gNB). However, the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless device 130 are illustrated in FIG. 1, any number of access nodes and wireless devices can be implemented within environment 100.

As further described herein, by utilizing antennas, access node 110 can deploy a wireless air interface 125 using one or more frequency bands over one or more coverage areas 116. Further, the different sets of antennas can be used to implement various transmission modes or operating modes in each sector, including but not limited to multiple in multiple out (MIMO), carrier aggregation (including inter-band and intra-band carrier aggregation), and different duplexing modes including frequency division duplexing (FDD) and time division duplexing (TDD).

Wireless device 130 may be any device, system, combination of devices, or other such communication platform capable of communicating wirelessly with access node 110 using one or more frequency bands deployed therefrom. Wireless device 130 may be, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device as well as other types of devices or systems that can exchange audio or data via access node 110. The FWA devices may include, for example, customer premises equipment (CPE). Additionally, wireless devices have evolved to include Internet of things (IoT) devices, which describes the network of physical objects or things that are embedded with sensors, software, and other technologies for the purpose of connecting and exchanging data with other devices and systems over the Internet. The wireless device 130 can be end-user wireless devices (e.g., user equipment (UEs)) utilizing communication links 125, which may operate based on 6G, 5G new radio (NR), 4G long term evolution (LTE), or any other suitable type of ratio access technology (RAT).

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless device 130. Wireless network protocols can comprise multimedia broadcast multicast services (MBMS), code division multiple access (CDMA) single-Carrier radio transmission technology(1xRTT), Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106, 108, and 109 can use various communication media, such as air, space, metal, optical fiber, or some other signal propagation path-including combinations thereof. Communication link 106 can be wired or wireless and use various communication protocols such as Internet, Internet protocol (IP), local-area network (LAN), optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol as described herein. Communication links 106, 108, and 109 can be a direct link or might include various equipment, intermediate components, systems, and networks. Communication links 106, 108, and 109 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, NFs, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

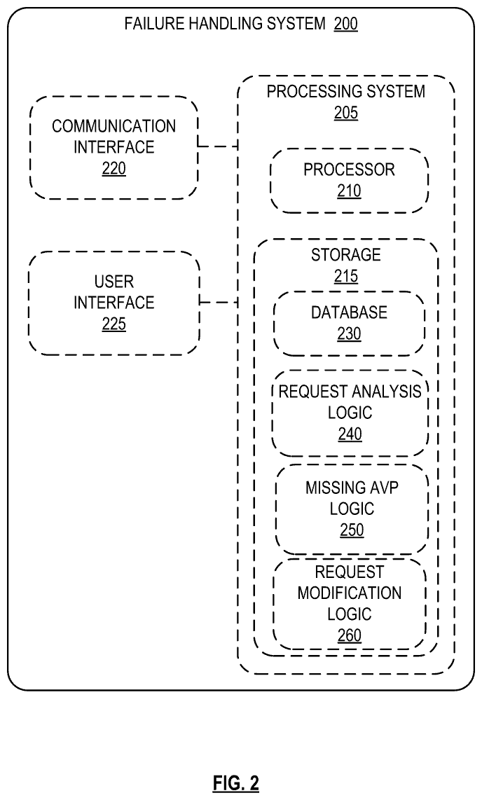

FIG. 2 illustrates a failure handing system 200 in accordance with embodiments described herein. The components described herein are merely exemplary as many different configurations for the failure handling system 200 may be implemented. The failure handing system 200 may be configured to perform the methods and operations disclosed herein to dynamically detect missing AVPs in requests from requesting functions. The failure handling system 200 may further trigger insertion of an indicator of the missing AVPs in an answer from an answering function. Finally, the failure handling system 200 may trigger identification of the missing AVP in the answer and insertion of the missing AVP in a further request by the requesting function.

In the disclosed embodiments, the failure handling system 200 may be integrated with the core network 102, for example with the answering function 150 or may be integrated with the IMS core 180, for example, with the requesting function 160. Alternatively, the failure handling system 200 may be an entirely separate component capable of communicating with at least the requesting function of the IMS 180 and the answering function or the core network 102. Further, the components of the failure handling system 200 may be distributed so that one or more components are located within the answering function 150, the requesting function 160, other NFs, and/or a separate processing node in communication with or integrated with the core network 102.

The failure handling system 200 may be configured for performing the operations described herein utilizing a processing system 205. Processing system 205 may include a processor 210 and a storage device 215. Storage device 215 may include a random access memory (RAM), read-only memory (ROM), disk drive, a flash drive, a memory, or other storage device configured to store data and/or computer readable instructions or codes (e.g., software). The computer executable instructions or codes may be accessed and executed by processor 210 to perform various methods disclosed herein. Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein.

For example, request analysis logic 240 may be operable to analyze a request from a requesting function 160 in order to identify missing AVPs. The request analysis logic 240 may communicate with the answering function 150 that receives the request from the requesting function in order to perform the analysis. Missing AVP logic 250 may operate to trigger insertion of an indicator of the missing AVP into the answer in response to the determination that one or more AVPs are missing. The missing AVP logic 250 may further trigger recognition of the indicator in the answer at the requesting function receiving the answer. Further, the missing AVP logic 250 may enable identification of the missing AVP. Request modification logic 260 may be triggered to generate a further request upon identification of a missing AVP. The further request contains the missing AVP and is transmitted from the requesting function 160 to the answering function 150. Further, the storage area 215 may include a database 230. The database 230 may store missing AVP indicators correlated with AVPs and may be accessible to both requesting functions and answering functions. To perform the above-described operations, the request analysis logic 240, the missing AVP logic 250, and the request modification logic 260 may be executed by the processor 210 to manage identification and transmission of missing AVPs.

Processor 210 may be a microprocessor and may include hardware circuitry and/or embedded codes configured to retrieve and execute software stored in storage device 215. The failure handling system 200 further includes a communication interface 220 and a user interface 225. Communication interface 220 may be configured to enable the processing system 205 to communicate with other components, nodes, or devices in the wireless network.

Communication interface 220 may include hardware components, such as network communication ports, devices, routers, wires, antenna, transceivers, etc. User interface 225 may be configured to allow a user to provide input to the failure handling system 200 and receive data or information from other system components. User interface 225 may include hardware components, such as touch screens, buttons, displays, speakers, etc. The failure handling system 200 may further include other components such as a power management unit, a control interface unit, etc.

The location of the failure handling system 200 may depend upon the network architecture. As set forth above, the failure handling system 200 may be located in the core network 102, in the IMS 180, in a separate processing node, in the requesting function 160, the answering function 150, or in multiple locations. Further, although shown as a single integrated system, the failure handling functions may be separated and be disposed in separate locations.

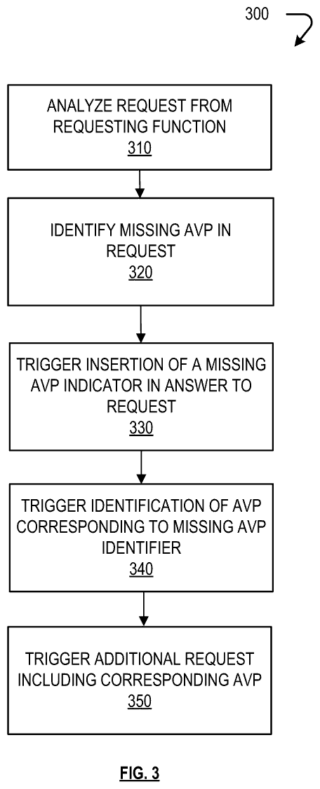

FIG. 3 illustrates a generalized exemplary method 300 for failure handling in accordance with embodiments disclosed herein. Method 300 may be performed by a processor, for example, the processor 210 included in the failure handling system 200. For discussion purposes, as an example, method 300 is described as being performed by the processor 210 of the failure handling system 200. However, it should be understood that the steps illustrated in FIG. 3 are performed in conjunction with the requesting function 160 and the answering function 150 and that processor 210 may, in fact, be incorporated in either or both of these functions.

Method 300 starts in step 310, in which the processor 210 analyzes a request from a requesting function 160. For example, with reference to FIG. 1, the requesting function, shown as PCSCF 160 generates and forwards a request to the answering function 150, which may be, for example, a PCF or a PCRF. The processor 210 analyzes the request received by the answering function 150 in step 210. The request may be or include, for example, a diameter authentication and authorization request such as an Rx/AA request.

In embodiments provided herein, request analysis logic 240 is executed by the processor 210 to identify one or more missing AVP in step 320. The identification of the one or more missing AVP in step 320 causes the missing AVP logic 240 to trigger insertion of a missing AVP indicator in an answer to the request formulated by the answering function 150 in step 330.

In embodiments proposed herein, the missing AVP logic 240 may interact with the PCF/PCRF 150 to check for an AF-Application-Identifier AVP within a Media-Component-Description AVP in the received Rx/AA request. If the AF-Application-Identifier AVP is missing, the missing AVP logic 240 interacts with the PCF/PCRF 150 to modify a call flow state machine by initiating a response Rx/AA answer with an Experimental-Result-Code AVP set to MISSING_AF_APPLICATION_ID. Thus, the missing AVP indicator is inserted as a value into an experimental result code AVP field.

In step 340, after the requesting function 160 has received the answer with the missing AVP indicator included, the processor 210 triggers identification of the missing AVP based on the indicator. The identification may be made using a database 230 that correlates indicators with AVPs. Thus, the processor 210 performs operations including matching the inserted value with a stored value. The processor 210 locates an AVP corresponding to the indicator in step 340. For example, the processor 210 identifies the inserted value as corresponding to the identified AVP. Thus, in the example provided herein, the PCSCF160 using the processor 210, upon receiving Rx/AA answer, may check the response for Experimental-Result-Code AVP.

Finally, in step 350, the processor 210 triggers an further request including the corresponding missing AVP. Thus, the triggered further request is sent from the requesting function 160 to the answering function 150 and includes one or more AVPs that were missing from the original request. Thus, in the example provided herein, if the Experimental-Result-Code AVP value is set to MISSING_AF_APPLICATION_ID, then the processor 210 will trigger generation a further Rx/AA request by inserting the missing AF_APPLICATION_ID AVP within a Media-Component-Description AVP.

The processor 210 may trigger at the PCF/PCRF 150, upon receiving the previously missing AF_APPLICATION_ID AVP within the Media-Component-Description AVP in the further Rx/AA request, the subsequent sequential call flow state machine procedures eventually leading to a successful dedicated bearer setup.

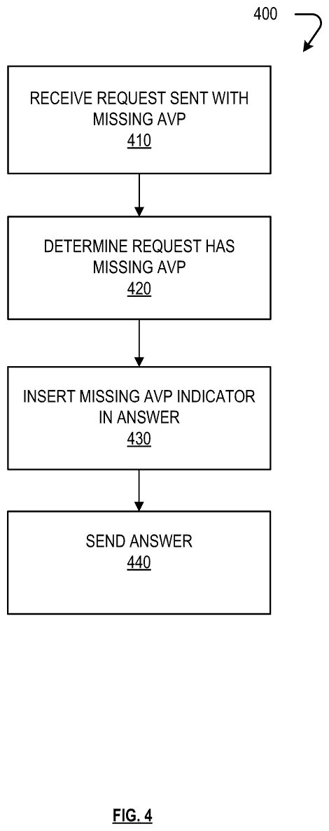

FIG. 4 depicts a further exemplary method 400 for failure handling from the perspective of an answering function 150, such as the PCF or PCRF. Method 400 may be performed by any suitable processor discussed herein, for example, the processor 210 included in the failure handling system 200 or another processor of the core network 102. For discussion purposes, as an example, method 400 is described as being performed by answering function 150 and the processor 210 included in the failure handling system 200, which may be partially incorporated in the answering function 150. However, the answering function 150 may be separate from the failure handling system 200 in other example implementations.

Method 400 starts in step 410, in which the answering function 150 receives the request from the requesting function 160. In step 420, the processor 210 determines that the request has a missing AVP and identifies the missing AVP.

After identifying the missing AVP, the processor 210 inserts a missing AVP indicator into the answer formulated by the answering function 150. The missing AVP indicator may, for example, be identified and retrieved from the database 230. The missing AVP indicator may be, for example, inserted in an existing AVP. Finally, in step 440, the answering function 150 sends the answer to the requesting function 160, where the answer includes the missing AVP indicator.

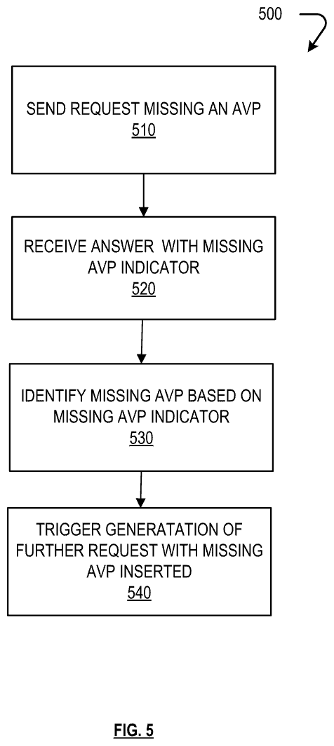

FIG. 5 depicts an additional exemplary method 500 for failure handling from the perspective of a requesting function 160 in accordance with an embodiment. Method 500 may be performed by any suitable processor discussed herein, for example, the processor 210 in the failure handling system 200, which may be partially incorporated in the requesting function 160, or a processor of the IMS core 180. For discussion purposes, as an example, method 500 is described as being performed by the processor 210 included in the failure handling system 200 and the requesting function 160. However, the requesting function 160 of the IMS core 180 may be separate from the failure handling system 200 in other example implementations.

In step 510, the requesting function 160 generates and sends a request. The request is missing one or more AVPs. In step 520, the requesting function 160 receives an answer to the request. The answer to the request was generated as described above and thus contains a missing AVP indicator. In step 530, the processor 210 identifies the missing AVP based on the missing AVP indicator, for example, by executing the missing AVP logic 250 as described above with respect to FIG. 2. In step 540, the processor 210 triggers generation of a further request from the requesting function 160. The further request includes the missing AVP.

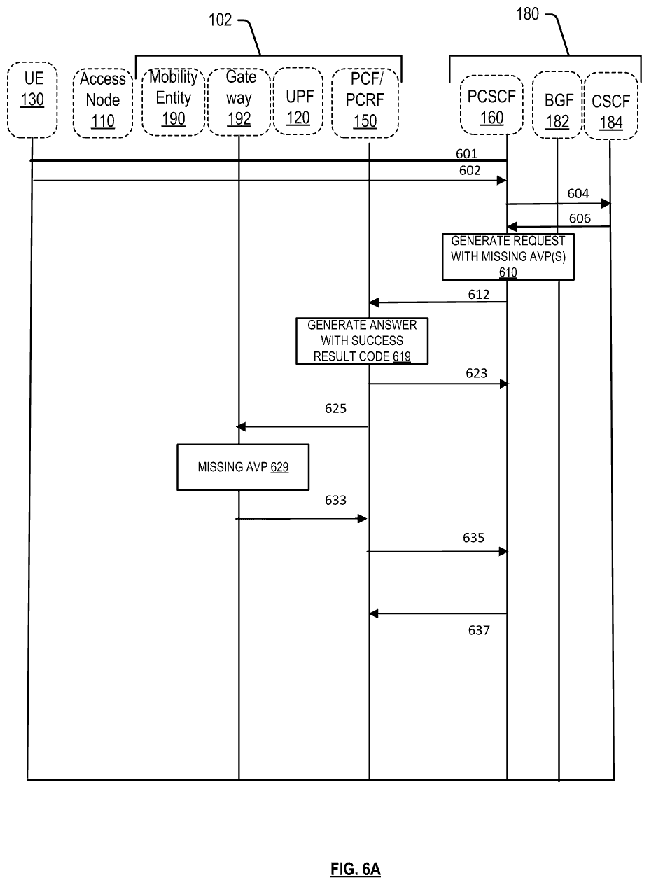

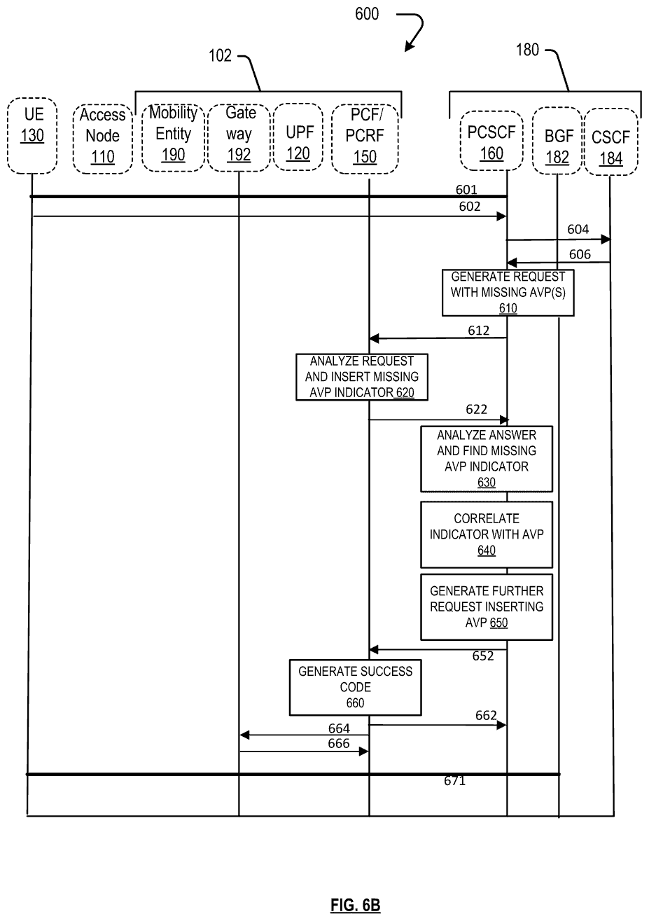

FIG. 6A illustrates conventional interactions between a requesting function and an answering function. More specifically, FIG. 6A illustrates a conventional interaction between a PCSF 160 and a PCF or PCRF 150.

The scenario illustrated in FIG. 6A expands the scope to show interactions between UE or wireless device 130, access node 110, the core network 102 and the IMS core 180. The illustrated core network components include a mobility entity 190, a gateway 192, a UPF 120 and a PCF or PCRF 150, which is also the answering function. The IMS core 180 is illustrated as including the PCSCF 160 as the requesting function, a border gateway function (BGF) 182 and a call session control function CSCF 184.

At the outset, a default bearer 601 is established between the PCSCF 160 and the wireless device 130. However, at step 602, the wireless device 130 sends a session initiation protocol (SIP) invite to the IMS core 180 to establish a session requiring a dedicated bearer. In step 604, the PCSCF 160 sends a SIP invite to the CSCF 184 to establish the session. In response, the CSCF 184 sends a SIP 183 session progress response to the PCSCF 160.

In response, in step 610, the PCSCF 160 generates a request that is missing one or more AVPs. For example, the PCSCF 160 fails to add an AF-Application-Identifier AVP within Media-Component-Description AVP in the Rx/AA request. PCSCF 160 detects that Rx/AA request is missing AF-Application-Identifier AVP but processes it as an optional AVP. Thus, the PCSCF 160 sends the request in step 612 to the PCF or PCRF 150. In step 619, the PCF or PCRF 150 generates an Rx/AA answer with a success result code without checking for missing AVPs. However, as AF-Application-Identifier AVP is missing in the Rx/AA request, the PCF/PCRF 150 cannot derive QoS parameters for the requested service data. Sequentially as per call flow state machine processing, the PCF/PCRF 150 continues process, with missing QoS parameters eventually causing dedicated bearer setup failure leading to application session binding failure.

The PCF or PCRF 150 forwards the Rx/AA answer with the success result code to the PCSCF 160 in step 623. Further, the PCF or PCRF 150 notifies the mobility entity 190 in step 625. The mobility entity 190 detects the one or more missing AVPs at step 629 and responds to the PCF or PCRF 150 with a 400 bad request code. In response, the PCF or PCRF 150 sends an Rx/abort session request to the PCSCF 160. The PCSCF 160 sends an Rx/abort session-answer and the process terminates without establishment of a dedicated bearer required for the services requested from the wireless device 130.

In order to avoid the scenario described above with respect to FIG. 6A, embodiments disclosed herein are described in connection with FIG. 6B, which illustrates modifications to the above-described process through introduction of a failure handling system 200 to ensure that a dedicated bearer can be deployed to provide requested services. Like reference numerals in FIG. 6B refer to like components described above with respect to FIG. 6A.

As set forth above, the default bearer 601 is established between the PCSCF 160 and the wireless device 130. At step 602, the wireless device 130 sends a session initiation protocol (SIP) invite to the IMS core 180 to establish a session requiring a dedicated bearer. In step 604, the PCSCF 160 sends a SIP invite to the CSCF 184 to establish the session. In response, the CSCF 184 sends a SIP 183 session progress response to the PCSCF 160. In response, in step 610, the PCSCF 160 generates a request that is missing one or more AVPs. For example, the PCSCF 160 fails to add an AF-Application-Identifier AVP within Media-Component-Description AVP in the Rx/AA request. The PCSCF 160 sends the request in step 612 to the PCF or PCRF 150.

At this point, the failure handling system 200 is triggered to analyze the received request. For example, the failure handling system 200 triggers the PCF/PCRF 150 to check for AF-Application-Identifier AVP within Media-Component-Description AVP in the Rx/AA request. If AF-Application-Identifier AVP is missing, the failure handling system 200 triggers the PCF/PCRF 150 to modify the call flow state machine by initiating a response Rx/AA answer with an Experimental-Result-Code AVP set to MISSING_AF_APPLICATION_ID. Thus, upon finding that the request is missing one or more AVPs, the failure handling system 200 inserts a missing AVP indicator into an answer formulated by the PCF/PCRF 150 in step 620. In step 622, transmission of the answer to the PCSCF 160 is triggered by the failure handling system 200.

Upon receipt of the answer by the PCSCF 160, the failure handling system 200 analyzes the received answer in step 630. Upon receiving the Rx/AA answer, the PCSCF 160 will check the response for Experimental-Result-Code AVP. Thus, the failure handling system 200 finds the missing AVP indicator through the analysis by correlating the missing AVP indicator with a corresponding AVP. For example, the PCSCF 160 determines that the Experimental-Result-Code AVP value is set to MISSING_AF_APPLICATION_ID. Upon making this finding, the failure handling system 200 in step 640 will trigger the PCSCF 160 to generate a further Rx/AA request after inserting the missing AF_APPLICATION_ID AVP within the Media-Component-Description AVP. Thus, the failure handling system 200 triggers insertion of the corresponding AVP into the Rx/AA request.

In step 652, the PCSCF 160 transmits the further request to the PCF/PCRF 150. Responsive to the further request, the PCF/PCRF upon receiving the previously missing AF_APPLICATION_ID AVP within Media-Component-Description AVP in Rx/AA request will trigger the subsequent sequential call flow state machine procedures eventually leading to a successful dedicated bearer setup. Specifically, the PCF/PCRF 150 generates a success code in step 660, and generates and transmits an Rx/AA answer including the success result code to the PCSCF 160 in step 662. Further, in step 664, the PCF/PCRF 150 sends a notification to the gateway 192 and receives a 200 OK message from the gateway 192 in step 666. Accordingly, a dedicated bearer 671 is then established between the wireless device 130 and the BGF 182 of the IMS 180. The dedicated bearer 671 may be linked to the default bearer 601 providing user plane resources for IMS services.

Accordingly, as set forth above, embodiments provide for NF de-registration upon isolation and re-registration upon restoration. In some embodiments, methods 300, 400, 500, and 600 may include additional steps or operations. Furthermore, the methods may include steps shown in each of the other methods. Additionally, the order of steps shown is merely exemplary and the steps may be re-ordered as appropriate. As one of ordinary skill in the art would understand, the methods 300, 400, 500, and 600 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
analyzing a request from a requesting function;
identifying a missing attribute value pair (AVP) in the request based on the analysis;
inserting a missing AVP indicator into an answer to the request;
identifying an AVP corresponding to the missing AVP indicator; and
generating a further request to be sent from the requesting function including the identified corresponding AVP.

2. The method of claim 1, wherein the requesting function is a proxy call session control function (PCSCF).

3. The method of claim 1, wherein the request and the further request include a diameter authentication and authorization (AA) request transmitted over an Rx interface.

4. The method of claim 1, wherein the answer is a diameter authentication and authorization (AA) answer transmitted over an Rx interface to the requesting function.

5. The method of claim 2, wherein the request and the further request are sent from the PCSCF to a policy control function (PCF) or a policy control and rules function (PCRF).

6. The method of claim 1, further comprising triggering a call flow leading to a dedicated bearer setup in response to the further request.

7. The method of claim 6, wherein the dedicated bearer is linked to a default bearer providing user plane resources for Internet protocol multimedia subsystem (IMS) services.

8. The method of claim 1, wherein the missing AVP indicator is inserted as a value into an experimental result code AVP field.

9. The method of claim 8, further comprising matching the inserted value with a stored value.

10. The method of claim 9, further comprising identifying the stored value as corresponding to the identified AVP.

11. A failure handling system comprising:
a memory storing data and instructions; and
at least one processor executing the stored instructions to perform operations including:
identifying a missing attribute value pair (AVP) in a request from a requesting function;
inserting a missing AVP indicator into an answer to the request;
identifying an AVP corresponding to the missing AVP indicator; and
triggering generation of a further request to be sent from the requesting function including the identified corresponding AVP.

12. The system of claim 11, wherein the request and the further request include a diameter authentication and authorization (AA) request transmitted over an Rx interface.

13. The system of claim 11, wherein the answer is a diameter authentication and authorization (AA) answer transmitted over an Rx interface.

14. The system of claim 11, wherein the request and the further request are sent from a proxy call session control function (PCSCF) to a policy control function (PCF) or a policy control and rules function (PCRF).

15. The system of claim 11, the operations further comprising triggering a call flow leading to a dedicated bearer setup in response to the further request.

16. The system of claim 11, wherein the missing AVP indicator is inserted as a value into an experimental result code AVP field.

17. The system of claim 16, further comprising matching the inserted value with a stored value.

18. A non-transitory computer readable medium storing instructions executed by a processor to perform operations comprising:
identifying a missing attribute value pair (AVP) in a request from a requesting function;
inserting a missing AVP indicator into an answer to the request;
identifying an AVP corresponding to the missing AVP indicator; and
triggering generation of a further request to be sent from the requesting function including the identified corresponding AVP.

19. The non-transitory computer readable medium of claim 18, wherein the request and the further request are sent from a proxy call session control function (PCSCF) to a policy control function (PCF) or a policy control and rules function (PCRF).

20. The non-transitory computer readable medium of claim 18, the operations further comprising triggering a call flow leading to a dedicated bearer setup in response to the further request.
